(19) United States
(12) Patent Application Publication
(10) Pub. No.: US 2006/0223512 A1
(43) Pub. Date: Oct. 5, 2006

(54) Method and system for providing a hands-free functionality on mobile telecommunication terminals by the temporary downloading of a speech-processing algorithm

(75) Inventors: Fred Runge, Wuensdorf (DE); Christel Mueller, Schulzendorf (DE); Marian Trinkel, Untermaubach (DE); Rainer Zelinski, Berlin (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Deutsche Telekom AG, Bonn (DE)

(21) Appl. No.: 10/565,629

(22) PCT Filed: Jun. 17, 2004
(86) PCT No.: PCT/DE04/01253

§ 371 Date: Jan. 23, 2006

(30) Foreign Application Priority Data
Jul. 22, 2003 (DE) 10333896.9

(51) Int. Cl. H04M 3/00; H04M 1/00

(52) U.S. Cl. 455/418; 455/569.1

(57) ABSTRACT

A method for carrying out hands-free communication using a telecommunication terminal includes loading, at least temporarily, at least one program from a service server into the telecommunication terminal and implementing the at least one program for use at least for a duration of a communication connection. The at least one program implements a speech processing algorithm.

The present invention relates to a method for carrying out a hands-free communication using a telecommunication terminal, especially a mobile telecommunication terminal, and to a system for providing such a hands-free communication, and to devices suitably adapted for use within such a system.

The prior art describes voice services that can be called using a telephone and which have server-based speech recognition (Automatic Speech Recognition, ASR) implemented therein. A dialog system connected to the telephone network allows communication between these services and a user, the aforementioned speech recognition forming a technical basis for this communication.

Such a server-based speech recognition generally includes programs for implementing algorithms for processing digitized speech data, and thus for recognizing spoken utterances of the user. Usually, in order to improve the recognition, echo cancellation and noise reduction methods are carried out in a preprocessing stage of the speech recognition on the respective server system connected to the telephone network.

Moreover, first attempts have been made to implement similar speech recognition systems and corresponding preprocessing algorithms on telecommunication terminals, such as a personal digital assistant (PDA), or a multimedia digital assistant (MDA). However, since in such terminals, the memory capacity for the software to be permanently installed is generally insufficient to provide comprehensive functionality, the preprocessing algorithms used do not reach the standard of the server-based speech recognition solutions, especially in terms of quality, and, in addition, a much smaller vocabulary is used.

A further approach for speech recognition is based on Distributed Speech Recognition (DSR), which is described in the literature. Here, the preprocessing is done in the telecommunication terminal connected to the telephone network, that is, for example, in a mobile PDA, MDA, or the like. In the process, feature vectors resulting from the preprocessing are subsequently transmitted at a reduced data rate over the telephone network to a server, where they are fed to subsequent processing stages of a speech recognition unit. However, this technology, which requires the definition of new interfaces in the transmission network, is still under development and will probably not come to fruition until in a few years, provided that reduced data rates then still play an important role in the transmission of speech data.

Furthermore, the legislatures of various countries have ruled that hands-free telephone systems must be used when telecommunication terminals, such as the aforementioned MDA or PDA, or a telephone, including a cordless or mobile telephone, are used in a moving vehicle, for example, for the purpose of using voice services.

Such hands-free telephone systems generally include a so-called level discriminator to prevent feedback between the microphone and the loudspeaker. When extraneous noise is present, these level discriminators may cause fluctuations in the volume level, which is not of much consequence for interhuman communication, but which, in the case of speech recognition, extremely reduces the speech recognition rates of the respective voice services. As a result, in particular, such voice services can no longer be used, or used only to a limited extent.

Unlike in mobile applications, so-called hands-free boxes exist for stationary applications in the fixed network. In these hands-free boxes, digital hands-free algorithms are implemented on a hardware module, said hands-free algorithms overcoming the disadvantages of the level discriminators and allowing improved use, in particular, of voice-operated services.

It is an object of the present invention to provide a method which is new and significantly improved over the aforementioned prior art, and by which an extremely flexible hands-free functionality may be provided for telecommunication terminals in general, but in particular for the aforementioned mobile telecommunication terminals, which generally have only a very limited memory capacity.

Most surprisingly, the object of the present invention is already achieved by the respective subject matters and features set forth in the independent claims appended hereto.

Advantageous and/or preferred embodiments and refinements are the subject matter of the respective dependent claims appended hereto.

Thus, the present invention proposes a method for carrying out a hands-free communication using a telecommunication terminal, especially a mobile telecommunication terminal, where at least one program for implementing a speech processing algorithm, especially a hands-free algorithm, is temporarily or permanently loaded from a service server into the communication terminal and implemented for use, at least for the duration of a communication connection.

Thus, a particular important advantage is that, due to the only at least temporarily loaded algorithm, speech processing functionality is enabled in particular also for hands-free talking with telecommunication terminals such as a PDA, MDA or a mobile telephone, which have no or only very little memory capacity, and especially ROM capacity, and also that, similar to human-to-human communication, the speech signals may be transmitted during the telecommunications connection.

Consequently, a voice service, for example one based on a server-based speech recognition, such as ASR, can already be used under hands-free conditions using the existing interfaces of existing telecommunications networks, that is, without the need to additionally agree on, or standardize, new or additional interfaces, as is the case, for example, in distributed speech recognition DSR.

In order to improve the quality and/or to verify transmitted speech signals, especially for subsequent speech recognition, a preferred refinement of the present invention provides for the loading to include the loading of at least one echo cancellation and/or noise reduction algorithm from the service server. Furthermore, if, in addition or alternatively, at least one voice and/or speaker verification, recognition, and/or classification algorithm is loadable from the service server, then this allows a user and/or a voice to be verified in an application-specific manner, for example, as being registered with a service, to be identified, for example, from a group of individuals, and/or to be classified as male or female. In a further advantageous embodiment, it is possible to load a program for implementing a text-to-speech algorithm, that is, for automatic conversion of text into speech.

The speech signals to be transmitted are preferably digitized for transmission, in which process the speech signals may additionally be encoded, depending on the telecommunication terminal used, for example, based on a terminal operating according to the GSM standard. Preferred embodiments of suitably adapted devices therefore include A/D and/or D/A converters, and are designed in a system-application specific manner for using, in particular, digital algorithms.

Based on the, possibly, temporary loading of at least one algorithm from the service server, on which, advantageously, a plurality of algorithms are stored for temporary loading, provision is made for said server to be located such that it is centrally accessible via at least one communication network in order to further increase flexibility, especially with respect to provisioning and access capacities. Thus, connections between one or a plurality of telecommunication terminals and the service server may easily be established substantially independently of location over the at least one communication network, which may be a radio communication network, a fixed network and/or the Internet.

In accordance with a first preferred embodiment, such a connection may be established directly between the service server and a particular telecommunication terminal. Preferably, such a connection for loading at least one algorithm or the program for implementing an algorithm is established in response to an automatic or user-defined request signal by the telecommunication terminal.

Furthermore, in particularly preferred embodiments of the present invention, a connection between the telecommunication terminal and a server-based speech recognition system is established over at least one communication network.

Especially in such embodiments, it is additionally or alternatively provided that the connection between the service server and the telecommunication terminal for, possibly, temporarily loading at least one algorithm is established in response to a request signal of the server-based speech recognition system.

To allow extremely flexible use, the method of the present invention provides that the connection between the telecommunication terminal and the at least one communication network be by wire or wireless, in accordance with the specific application. Thus, the present invention makes it possible to connect substantially any telecommunication terminal, and to carry out the inventive method using essentially any communication network, especially a mobile telecommunications network, for example one based on GSM (Global System for Mobile Communication) or UMTS (Universal Mobile Telecommunication System), a (W)LAN network ((Wireless) Local Area Network) and/or a fixed network, as is the case, for example, when the telecommunication terminal used is a DECT (Digital Enhanced Cordless Telecommunication) telephone.

The inventive arrangement of a server-based speech recognition system and/or the service server can also be implemented in an extremely flexible and application-specific manner. In particular, it is preferred for the server systems to integrated directly into a radio communication network or a fixed network. Here, an intelligent network may be included, so that the server system or systems is/are disposed, for example, in a service switching point and have access to an intelligent periphery. In a complementary or alternative embodiment, provision is also made for the server systems to be configured to have connections to the Internet using WEB servers, which are essentially computers and/or software which, in a network, provide HTTP (Hypertext Transfer Protocol) and access to the Internet. In this case, the telecommunication terminals contain interface devices for providing communication connections over the Internet.

Thus, using the present invention, a connection between the telecommunication terminal and the service server and/or the server-based speech recognition system and/or between the speech recognition system and the service server can particularly advantageously be established by setting up a call using respectively assigned identifiers. Consequently, in a preferred practical embodiment, the present invention allows the use of a plurality of such identifiers, which, in particular, differ according to the specific application, depending on the telecommunications networks, servers and/or telecommunication terminals used. Such identifiers may include, for example, subscriber numbers and/or service numbers, IP addresses, calling line identifiers (CLI—Calling Line Identification; ANI—Automatic Number Identification) and/or identification addresses which are assigned to mobile telephones and stored in a Home Location Register (HLR) of a respectively associated communication network.

In another advantageous refinement, provision is also made for the telecommunication terminal to be configured for multi-channel signal processing. Thus, it may also be ensured that, for example, when connecting a plurality of microphones via a respective audio and/or stereo input, the quality of especially a noise reduction can be further improved significantly by locating the speech source, which will then, in principle, be possible. Multi-channel processing can also be carried out on the server, which then requires multi-channel or virtually multi-channel (multiplex) transmission between the server and the terminal.

If the telecommunication terminal has at least two microphone channels, such as a stereo channel, then a hands-free algorithm which performs multi-channel processing, especially for locating the speech source for improved noise reduction, can advantageously be loaded into the telecommunication terminal. If the telecommunication terminal additionally includes at least two loudspeaker channels and if the signal transmission is multi-channel or virtually multi-channel (multiplex), then a stereo or hands-free algorithm and/or stereo or multi-channel echo cancellation, especially for hands-free transmission including three-dimensional perception, can preferably be loaded into the telecommunication terminal.

Multi-channel transmission further has the advantage that, for example, in addition to speech data, further specific parameters, vector data, test and/or compensation signals, can be easily transmitted, which would otherwise have to be transmitted embedded in the mono signal together with the speech data, as required.

In particular, using such test and/or compensation signals, the algorithm used can be tested, at substantially all times, with respect to the respective current environment conditions. For this purpose, preferably, a comparator unit is provided by which a test signal that is output by a loudspeaker on the side of the telecommunication terminal is compared to the signal receivable via a microphone of the telecommunication terminal.

Depending on the specific application, such a test is performed in response to a test signal which is transmitted by the server-based speech recognition system and/or the service server, or which is generated by the telecommunication terminal. The present invention further includes embodiments in which the actual comparison check of the two signals is performed immediately in the telecommunication terminal, or after the received signal is transmitted back to one of the server-based systems.

Thus, the updating of an algorithm, i.e., the adjustment, adaptation, or replacement of the at least one used algorithm according to the respective current environment, is performed in response to the test result, for example, by loading an appropriate program from the service server or, if a plurality of algorithms are, at least temporarily, loaded on the telecommunication terminal, by the telecommunication terminal autonomously selecting the appropriate algorithm.

In order to further increase the quality of the speech recognition and the flexibility in the use of different frequency spectra and/or bands, the present invention preferably also provides a functionality for converting the speech signals for transmission between communication units operating at different frequencies, for example, from a telecommunication terminal processing speech signals on a 30 kHz basis for a communication connection provided on an 8 kHz basis by a communication network used, which may be followed by re-conversion to 30 kHz via a conversion unit respectively associated with the server-based speech recognition.

According to a further advantageous refinement of the present invention, it is further proposed that specific identification parameters and/or charging parameters be transmitted by the telecommunication terminal for further processing and recorded by a device associated with the speech recognition system and/or with the service server.

Thus, especially if, on the service server and/or the server of the speech recognition system, such identification parameters are associated with algorithms that are particularly suited for the respective telecommunication terminal, then, based on parameters transmitted in this manner, suitable algorithms to be temporarily loaded can be advantageously preselected in a time-saving manner already when a telecommunication terminal logs on again and/or repeatedly to one of the server systems.

Furthermore, using application-specific charging parameters, possibly in conjunction with the identification parameters, a preferably automatic invoicing and/or debiting process associated with the telecommunication terminal and/or the user of the telecommunication terminal for invoicing and/or debiting chargeable services and/or algorithms can be implemented very easily with essentially all invoicing and/or debiting methods generally known for this purpose.

Moreover, in a practical embodiment of the present invention, an analog-to-digital conversion and/or a digital-to-analog conversion to be performed on the side of the telecommunication terminal is calibrated before or during the use of a temporarily implemented algorithm. Such calibration can be performed once for a communication connection, or continuously. In particular, for flexible, environment-based use or selection of suitably adapted algorithms of a common group, or of a common provider, it is also advantageous for a calibration to be performed digitally, especially using a processor which forms part of the telecommunication terminal and executes a particular algorithm.

Moreover, it is provided that compensation signal used for the thus substantially universally usable calibration is the speech signal itself and/or suitably designed test signals, such as a noise signal emitted during speech pauses via the loudspeaker of the telecommunication terminal and received back via the microphone of the telecommunication terminal.

Thus, the present invention further includes a system, in particular as set forth in the appended claims, which is suitably designed for carrying out the inventive method and which, in the particular embodiments thereof, has advantages identical or comparable to those mentioned above.

Further advantages and characteristics of the present invention will be apparent from the following description of preferred, but only exemplary embodiments of the invention with reference to the accompanying drawings.

In the drawings,

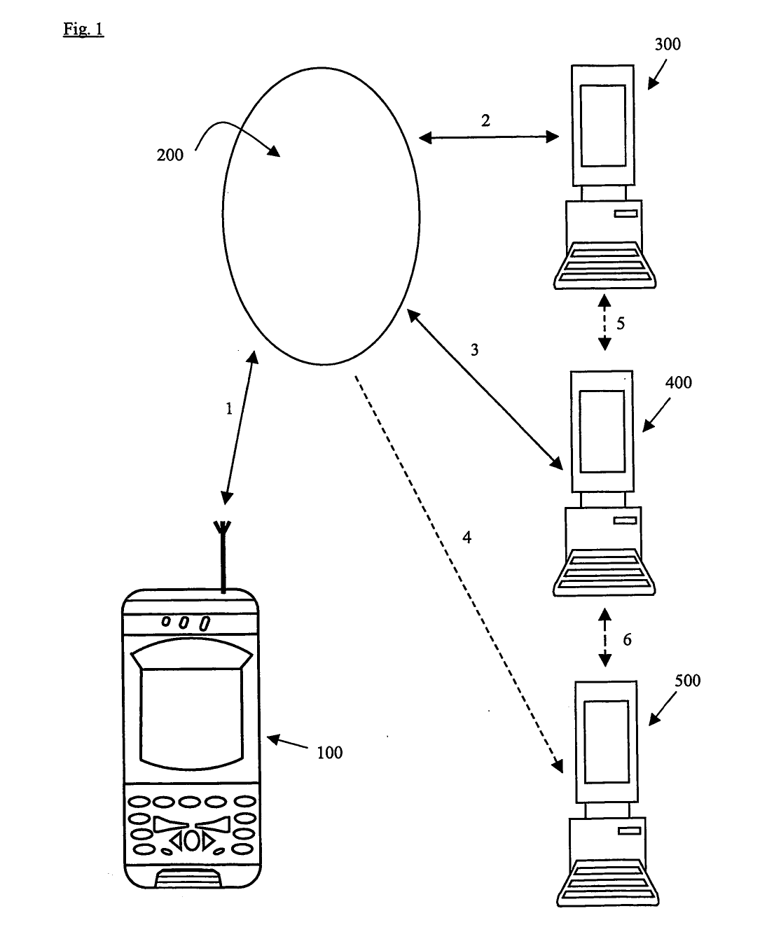

FIG. 1 is a greatly simplified schematic representation of a system according to the present invention; and

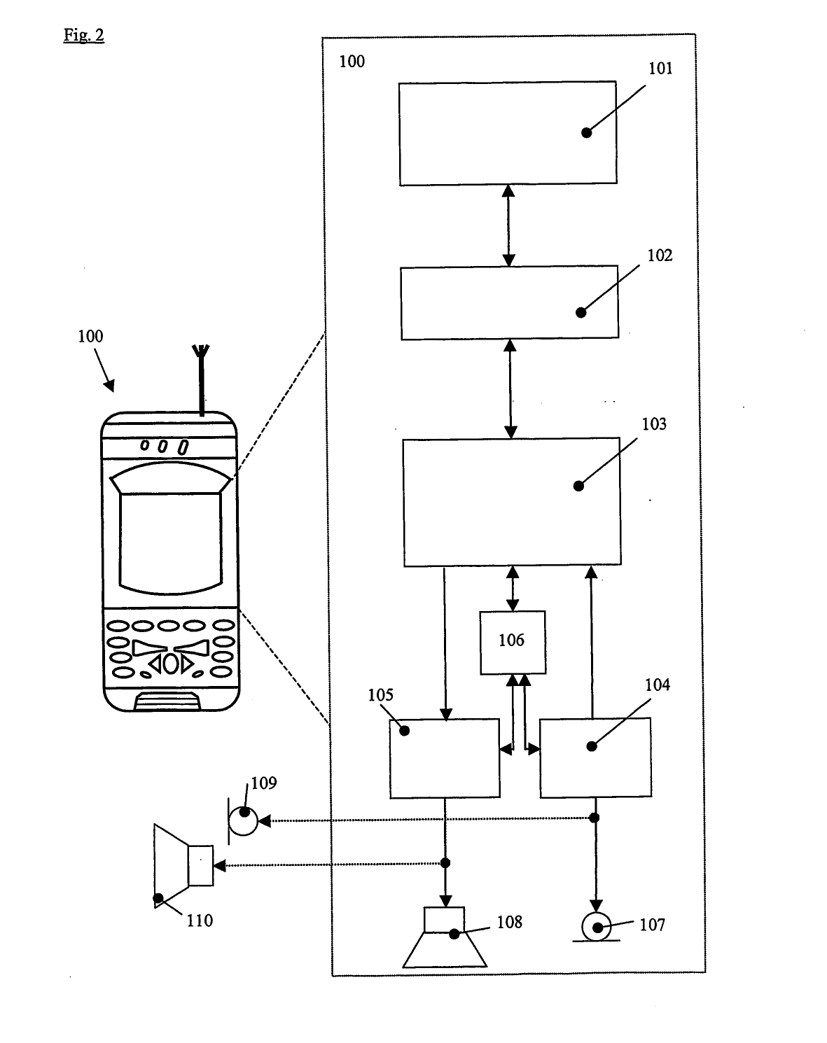

FIG. 2 is a simplified block diagram for illustrating a local processing principle for the inventive hands-free functionality on a mobile telecommunication terminal according to the present invention.

In the following, preferred embodiments of the present invention will be described by way of example with reference to FIGS. 1 and 2, which show a schematic representation of a hands-free system according to the present invention and a block diagram for illustrating a local processing principle according to the present invention for using a hands-free functionality on a mobile telecommunication terminal.

FIG. 1 shows a mobile telecommunication terminal 100 which is able to access a telecommunications network 200 via an air interface, for example, by radio, as indicated by double arrow 1. The double arrow further indicates that a duplex communication, conveniently a full-duplex communication, is provided via the air interface. In the case under discussion, telecommunication terminal 100 is a mobile telephone, a PDA, or an MDA, which, on the basis of a GSM standard, is able to communicate over a mobile telecommunications network which, in the present case, is included in telecommunications network 200, and thus, to transmit speech data over network 200 in a manner corresponding to human-to-human communication.

However, it should be pointed out that the mobile telecommunications network and the telecommunication terminal 100 associated therewith may also be based on a different standard, such as a UMTS Standard. Moreover, it should be noted that the term “telecommunications network” used in the following description and the appended claims should be understood to generally refer to only one communications network or to a plurality of communications networks, including voice/data networks and data/data networks.

Via at least one further interface, which is indicated by double arrow 2, a voice-operated CT server (computer telephony server) 300 having speech recognition algorithms is connected permanently or as needed to telecommunications network 200, which is suitable for transmission of speech data, said connection being established directly via the mobile telecommunications network or via further communication networks not shown.

Furthermore, a connection 3 is established permanently or as needed to a service server 400 containing a plurality of digital hands-free algorithms and, possibly, further audio signal preprocessing algorithms, such as, in particular, echo cancellation and/or noise reduction algorithms.

The illustrated system configuration further includes a third server 500, which is part of a charging or charge invoicing and debiting system, which is essentially a so-called billing system or billing support system (BSS). In the case under discussion, a simplex connection 4 can be established to said third server via telecommunications network 200.

Servers 300, 400 and 500 preferably include direct connections 5, 6 allowing them to communicate and/or exchange data between each other, so that, in an alternative embodiment, only connection 2 from servers 300, 400 and 500 to telecommunications network 200 is needed for carrying out the inventive method, which will be described in detail below. In another alternative embodiment, servers 300, 400 and 500 may be part of a shared server system.

When using the illustrated system configuration in accordance with a preferred embodiment in which servers 300, 400 and 500 are in the form of, for example, a WEB server, a service server 400 provides in each case at least one program for implementing a hands-free algorithm for mobile telecommunication terminal 100, said at least one program being able to be loaded from the Internet via telecommunications network 200. This at least one program is temporarily loaded into mobile telecommunication terminal 100 and implemented thereon for using a voice service provided by server 300. Since, generally, a main memory is already sufficient for temporary loading, mobile telecommunication terminal 100 needs essentially no hard disk storage capacity in this case. However, in specific applications, it is still possible to use such storage capacity.

Depending on the environment condition currently present, for example, when using mobile telecommunication terminal 100 in a particular vehicle which represents a different noise environment than when using mobile telecommunication terminal 100 in the open air or in a differently designed vehicle, a respectively suitable algorithm of the plurality of algorithms provided on a mass storage unit in service server 400 can thus in each case be temporarily loaded into telecommunication terminal 100 and implemented thereon, even in the case of extremely limited memory capacity. After the memory capacity has been used for a specific purpose, it is made available for other applications again.

Depending on the respective, especially application-specific design, the at least one algorithm is transmitted, for example, when server 300 and or server 400 is/are called for the first time based on a particular service subscribed, or when directly requested by the user of mobile telecommunication terminal 100.

Thus, unlike in the case of distributed speech recognition, i.e. unlike in DSR, no feature vectors are required during the subsequent communication between mobile telecommunication terminal 100 and speech recognition system 200 and/or when establishing a communication connection to another telecommunication terminal. Rather, regular speech data is transmitted, which, in the example under discussion, is GSM-coded speech data.

As can be seen from FIG. 2, a preferred embodiment provides for the mobile telecommunication terminal 100 to include a transmitting/receiving unit 101, an encoder unit 102, and a processor unit 103 which is connected to the temporary memory and is able to execute an algorithm temporarily loaded into the memory. Processor unit 103 is connected to a digital-to-analog converter 105, which is connected to an internal loudspeaker 108, or which may additionally or alternatively be connected to an external loudspeaker 110, for example, via an infrared or Bluetooth interface, or via a wired interface. A connection from an internal microphone 107 to processor unit 103, or, analogously, from an external microphone 109 to said processor unit via an interface, is provided via an interposed analog-to-digital converter 104. Furthermore, a calibration control unit 106, which is capable of being controlled by processor unit 103, is provided for calibrating converters 105 and 104. Advantageously, converters 104 and 105, or an associated unit, additionally provide signal amplification, especially an adjustable signal amplification.

Depending on the specific design, a calibration of converters 104 and 105 is performed once each time telecommunication terminal 100 is placed into service, or during operation, for example, continuously or monitored in a time-based manner.

It is also possible to perform a digital calibration, for example, based on the signal which is present at processor unit 103 and which is fed to converter 105 or received by converter 104. Such calibration is preferably specifically matched to a particular group of temporarily loadable algorithms, especially using a suitable assignment and/or combination scheme or schemes.

Thus, in accordance with the embodiment of FIG. 2, before digital speech signals which are transmitted from speech recognition system server 300 over telecommunications network 200 to mobile telecommunication terminal 100 are output on loudspeaker 108 or 110, they are supplied to the hands-free algorithm, which is activated by processor unit 103, in digitized form for further processing and subsequently fed to loudspeaker 108 and/or loudspeaker 110 via digital-to-analog converter 105.

Analogously, a speech signal received by microphone 107 and/or microphone 109 is digital-to-analog converted by converter 104, possibly amplified in a suitably adapted manner, and subsequently fed to processor unit 103 and processed by the activated hands-free algorithm before it is transmitted over telecommunications network 200.

Thus, without the need to additionally agree on, or standardize, new interfaces, as would otherwise be the case with DSR, the present invention allows voice services to be used under hands-free conditions already under the present conditions, using the existing interfaces, and thus, to be used in particular also inside a vehicle.

Since, as mentioned above, additional algorithms are preferably provided on service server 400 for at least temporary loading, a very particularly preferred embodiment provides that, in addition to the at least one hands-free algorithm, for example, noise reduction algorithms are also temporarily loaded into telecommunication terminal 100 in an analogous manner in order to be executed by processor unit 103.

If, for example, the latter algorithms are executed on mobile telecommunication terminal 100 in a vehicle, and if the mobile telecommunication terminal allows connection of several microphones, for example, via a stereo input, then it is also possible to significantly further improve the noise reduction quality by locating the speech source, i.e., by locating the speaker or the user of mobile telecommunication terminal 100, which will then, in principle, be possible. However, when executing a noise reduction algorithm directly on speech recognition system server 300, there is generally only a mono signal available, which does allow noise reduction, but generally does not allow location finding.

Telecommunication terminal 100, server 300 and/or service server 400 preferably transmit charging and/or identification parameters to charging server 500 for the period of use of the speech recognition service provided via server 300 and/or for the use of an algorithm of service server 400, said parameters allowing the service to be invoiced. The invoicing and/or debiting of accounts can be done using essentially all methods that are known or which will be developed in the future.

The algorithm or algorithms carried out by processor unit 103 is/are checked for suitability under the current conditions, preferably using a compensation signal which is, for example, packed into a noise signal and output via loudspeaker 108 or 110 during speech pauses, received as a response signal via microphone 107 and/or microphone 109, and compared to the signal that was output.

When providing a suitable signal generator (not shown), such a test or compensation signal may be independently generated by the mobile telecommunication terminal, especially when mobile telecommunication terminal 100 has loaded thereon a plurality of algorithms capable of being selected for activation. However, such test or compensation signals can also be transmitted by server 300 and/or server 400 to mobile telecommunication terminal 100 and, upon receipt of the response signal, be compared to said response signal on the server or on a respectively associated test unit as to whether the currently activated algorithm is suitable, so that, if necessary, a suitably adapted and updated algorithm is transmitted from service server 400 to mobile telecommunication terminal 100 and temporarily loaded thereon.

If mobile telecommunication terminal 100 has a single-channel design, such a compensation or test signal is preferably embedded into the speech signal as a noise signal. In the case of a mobile telecommunication terminal 100 having two channels, said compensation or test signal may be transmitted over the additional channel.

The present invention further provides that, in the case of a two-channel mobile telecommunication terminal 100, additional parameters, such as the aforementioned identification parameters, further data and/or possibly also feature vectors be transmitted over the additional channel, i.e. essentially independently of the speech data, but possibly depending on the particular algorithm used, provided that the telecommunications network 200 used and/or interfaces 1 and 2 are suitably designed for this purpose.

The present invention further includes embodiments in which interfaces 1 and 2 have frequency bands that are different from the frequency band of mobile telecommunication terminal 100. For example, if the signal processing performed by telecommunication terminal 100 is based on a 30 kHz band, telecommunication terminal 100 preferably contains a conversion unit to convert the 30 kHz speech signal to, for example, an 8 kHz speech signal for transmission to voice-operated CT server 300. A conversion unit associated with CT server 300 possibly reconverts the so-received signals to the original 30 kHz signal in accordance with the specific application prior to speech recognition. Such signals, which may have to be converted, are identified using, for example, the additionally transmitted data or parameters mentioned above.

The present invention further includes embodiments in which algorithms to be transmitted are preselected based on identification parameters which specify telecommunication terminal 100 and which are transmitted and/or requested when speech recognition server 300 is called by telecommunication terminal 100. Such preselected algorithms can be preset for the specified telecommunication terminal 100, or may, in the past, have turned out to be suitable algorithms, for example based on an environment condition detected in the past with respect to telecommunication terminal 100. Subsequently, service server 400 is accordingly requested, for example via connection 5, to transmit the selected or preset algorithm. However, preselection is also possible in an analogous manner by-passing speech recognition server 300, that is, via interfaces 1 and 3 according to FIG. 1.

Such identification parameters may vary in accordance with the specific application and, depending on the telecommunication terminal used, may include an IP address, a CLI and/or a parameter extracted by server 300 from an HLR associated with telecommunication terminal 100.

Moreover, it is not essential to the present invention that telecommunication terminal 100 be a mobile telecommunication terminal. In principle, the telecommunication terminal used in the present invention can also be a stationary telecommunication terminal, or a telecommunication terminal that is permanently incorporated in a vehicle, and, depending on the underlying system, can also be designed to include a DECT, Bluetooth, (W)LAN, or other interface, including also a wired interface, for access to the corresponding network.

The entire telecommunications network 200 used may therefore vary in accordance with the specific application and may include, for example, mobile telecommunications networks, (W)LAN, fixed networks and/or the Internet.

Moreover, the telecommunications network used may include an intelligent network, in which case at least speech recognition system server 300 is preferably disposed in a service node and advantageously has access to an intelligent periphery.

In further preferred embodiments, service server 400 may also be designed directly with telecommunication terminal 100 to provide algorithms, while by-passing telecommunications network 200. Thus, for example, it is proposed in particular that service server 400 be part of an intelligent unit which is accommodated, for example, in a vehicle and on which a plurality of algorithms are available and that it be appropriately supplied with current algorithms over the telecommunications network from a central server unit, not shown in FIG. 1. Thus, a respectively suitable algorithm may be temporarily loaded from such a disposed service server into telecommunication terminal 100 also via a direct connection to telecommunication terminal 100.

Using call identifiers respectively assigned to the individual system components 100, 300, 400 and/or possibly 500 in an arrangement selected in accordance with the specific application, or in a given arrangement, it is thus possible to establish respective desired or necessary communication connections in a location-independent manner between the individual devices and/or systems for carrying out the method of the present invention.

Thus, such identifiers include in particular subscriber numbers and/or service numbers, IP addresses, calling line identifiers and/or identification addresses which are assigned to mobile telephones and stored in a home location register of a respectively associated communication network.

Thus, using the present invention, it is no longer necessary for a speech processing functionality, especially a hands-free and/or noise reduction or speech recognition functionality, to be permanently installed on a telecommunication terminal 100, so that the invention may be used especially in telecommunication terminals which have no or only very little memory, or which have insufficient capacity available in this memory, or if this capacity is intended to be used for other purposes.

Thus, for example, telecommunication terminal 100 may be pre-configured such that, when establishing a communication connection, it first automatically establishes a connection to service server 400 for temporarily loading one or possibly a plurality of algorithms into, and implementing the same on, telecommunication terminal 100, and that telecommunication terminal 100 may then appropriately select the respectively suitable algorithm.

If an implemented algorithm turns out to be no longer suitable and/or when the desired communication connection is terminated, the memory capacity, for example of the main memory, that is occupied by the algorithm is freed for other applications.

1-49. (canceled)

50. A method for carrying out a hands-free communication using a telecommunication terminal, the method comprising:
loading, at least temporarily, at least one program from a service server into the telecommunication terminal, the at least one program being configured to implement a speech processing algorithm; and
implementing the at least one program for use at least for a duration of a communication connection.

51. The method as recited in claim 50 wherein the telecommunication terminal is a mobile telecommunication terminal.

52. The method as recited in claim 50 wherein the speech processing algorithm includes at least one of a hands-free, an echo cancellation, a speaker verification, a speaker recognition, a speaker classification, a voice verification, a voice recognition, a text-to-speech and a noise reduction algorithm.

53. The method as recited in claim 50 further comprising establishing, over at least one communication network, a connection between the telecommunication terminal and a server-based speech recognition system.

54. The method as recited in claim 50 further comprising establishing a connection to the service server over at least one communication network so as to facilitate the loading.

55. The method as recited in claim 54 wherein the connection is established via an interposed server-based speech recognition system.

56. The method as recited in claim 54 wherein the connection is established between the service server and the telecommunication terminal in response to an automatic or user-defined request signal by the telecommunication terminal.

57. The method as recited in claim 54 wherein the connection is established between the service server and the telecommunication terminal in response to a request signal of a server-based speech recognition system.

58. The method as recited in claim 54 wherein the establishing the connection is performed using respectively assigned identifiers.

59. The method as recited in claim 58 wherein the respectively assigned identifiers include at least one of a CLI, an ANI and an HLR.

60. The method as recited in claim 50 further comprising transmitting speech signals and further signals during the communication connection.

61. The method as recited in claim 60 wherein the further signals include at least one of test signals, compensation signals, charging signals, identification parameters, and vector signals.

62. The method as recited in claim 50 further comprising selecting the speech processing algorithm using at least one of the telecommunication terminal, a speech recognition system, and the service server.

63. The method as recited in claim 50 further comprising loading the at least one program again during the communication connection.

64. The method as recited in claim 63 wherein the loading again is performed in an updating manner.

65. The method as recited in claim 50 further comprising transmitting, by the telecommunication terminal, at least one of a specific identification parameter and a charging parameter for further processing by a device associated with at least one of a speech recognition system and the service server.

66. The method as recited in claim 50 further comprising calibrating, by the telecommunication terminal, at least one of an A/D conversion and a D/A conversion.

67. The method as recited in claim 66 wherein the calibrating is performed at least one of once during the communication connection, continuously, and digitally.

68. The method as recited in claim 66 wherein the calibrating is performed using a compensation signal, the compensation signal being at least one of a speech signal and a test signal.

69. The method as recited in claim 67 further comprising performing a procedure for locating a speech source.

70. The method as recited in claim 69 wherein the performing the procedure for locating the speech source is performed for a multi-channel processing of at least two microphone signals.

71. The method as recited in claim 69 wherein the performing the procedure for locating the speech source is performed so as to achieve a noise reduction.

72. A system for providing hands-free communication for at least one telecommunication terminal, the system comprising a service server configured to:
provide at least one program for implementing a speech processing algorithm; and
transmit, in response to a defined request signal, the at least one program to the at least one telecommunication terminal for at least temporary implementation of the at least one program.

73. The system as recited in claim 72 wherein the at least one telecommunication terminal includes a mobile telecommunication terminal.

74. The system as recited in claim 72 wherein the speech processing algorithm includes at least one of a hands-free, an echo cancellation, a speaker verification, a speaker recognition, a speaker classification, a voice verification, a voice recognition, a text-to-speech and a noise reduction algorithm.

75. The system as recited in claim 72 further comprising at least one of a server-based speech recognition system, a charging system and a billing system.

76. The system as recited in claim 72 wherein the service server is provided by a WEB server, and further comprising at least one of a server-based speech recognition system, a charging and a billing system provided by the WEB server.

77. The system as recited in claim 75 wherein the service server is configured to communicate with at least one of the at least one telecommunication terminal, the server-based speech recognition system, the charging system and the billing system over a communications connection established using respectively assigned identifiers.

78. The system as recited in claim 72 further comprising a server-based speech recognition system configured to enable the at least one program to be selected and at least temporarily loaded and implemented on the at least one telecommunication terminal in response to identification parameters associated with the at least one telecommunication terminal.

79. The system as recited in claim 72 wherein the service server is configured to enable the at least one program to be selected and at least temporarily loaded and implemented on the at least one telecommunication terminal in response to identification parameters associated with the at least one telecommunication terminal.

80. The system as recited in claim 72 further comprising a server-based speech recognition system and at least one of a charging system and a billing system configured to charge, in response to at least one of an identification and a charging parameter associated with the at least one telecommunication terminal, for a service at least temporarily provided by a server-based speech recognition system to the at least one telecommunication terminal.

81. The system as recited in claim 72 further comprising at least one of a charging system and a billing system configured to charge, in response to at least one of an identification and a charging parameter associated with the at least one telecommunication terminal, for the at least temporary implementation of the at least one program.

82. A telecommunication terminal comprising a receiver configured to receive at least one program for implementing a speech processing algorithm transmitted, in response to a defined request signal, from a service server for at least temporary implementation of the at least one program.

83. The telecommunication terminal as recited in claim 82 wherein the speech processing algorithm includes at least one of a hands-free, an echo cancellation, a speaker verification, a speaker recognition, a speaker classification, a voice verification, a voice recognition, a text-to-speech and a noise reduction algorithm.

84. The telecommunication terminal as recited in claim 82 further comprising:
an A/D converter;
a D/A converter; and
a calibration device configured to at least one of calibrate the A/D and D/A converters and perform a digital calibration.

85. The telecommunication terminal as recited in claim 84 wherein the calibration device is configured to calibration automatically using at least one of a speech signal and a test signal as the compensation signal.

86. The telecommunication terminal as recited in claim 82 further comprising an encoder unit.

87. The telecommunication terminal as recited in claim 82 further comprising a conversion device configured to convert a speech signal between different frequency bands.

88. The telecommunication terminal as recited in claim 82 further comprising an interface device configured for at least one of wired and wireless connection of at least one of an external microphone and a loudspeaker.
